(19) United States
(12) Patent Application Publication
(10) Pub. No.: US 2026/0159357 A1
(43) Pub. Date: Jun. 11, 2026

(54) ELEVATOR ARRANGEMENT AND A METHOD FOR CONSTRUCTING AN ELEVATOR

(71) Applicant: Kone Corporation, Helsinki (FI)

(72) Inventors: Matti RÄSÄNEN, Helsinki (FI); Mika IJÄS, Helsinki (FI); Mikko KUKKOLA, Helsinki (FI); Markku HAAPANIEMI, Helsinki (FI)

(73) Assignee: Kone Corporation, Helsinki (FI)

(21) Appl. No.: 19/443,660

(22) Filed: Jan. 8, 2026

Related U.S. Application Data
(63) Continuation of application No. PCT/FI2023/050478, filed on Aug. 18, 2023.

(51) Int. Cl. B66B 11/00; B66B 7/06; B66B 19/02

(52) U.S. Cl. CPC B66B 11/0065; B66B 7/06; B66B 19/02

(57) ABSTRACT

The invention relates to an elevator arrangement comprising a hoistway; and one or more hoisting ropes; and a rope supply storage; and an elevator car and a counterweight in the hoistway, which elevator car and counterweight are interconnected by the one or more hoisting ropes; and a hoisting machine unit mounted in a first hoisting machine position in the hoistway; and a rope anchoring device mounted in a first rope anchor position in the hoistway, the rope anchoring device comprising a support structure and one or more rope wheels for guiding the one or more ropes, and rotatably mounted on said support structure; wherein the one or more hoisting ropes pass from the rope supply storage to the rope anchoring device, around the one or more rope wheels thereof, and from the rope anchoring device to one of the car and counterweight; wherein each said rope has a surface material which is or comprises polymer, and the one or more rope wheels comprise at least one rope wheel provided to be lockable from rotating. The invention also relates a method for constructing an elevator implementing the arrangement.

### CROSS-REFERENCE TO RELATED APPLICATIONS

This application is a continuation of PCT International Application No. PCT/FI2023/050478 which has an International filing date of Aug. 18, 2023, the entire contents of which are incorporated herein by reference.

### FIELD OF THE INVENTION

The invention relates to anchoring of hoisting ropes of an elevator arrangement, wherein the elevator arrangement is in particular a construction time elevator arrangement.

### BACKGROUND OF THE INVENTION

Such construction time elevator arrangements are known, hereinafter also referred to as jump-lifts, where the bottom part of an elevator hoistway is taken into transportation use already when the upper parts of the building and the hoistway are still under construction or even non-existent. In this kind of project, the upper parts of the building as well as the top part of the elevator hoistway can be constructed at the same time as an elevator car moving in the bottom part of the elevator hoistway already serves people on the lower floors of the building under construction. Typically in construction time elevator arrangements, the elevator car moving in the lower parts of the elevator hoistway is supported and moved during construction-time use with hoisting ropes movable with a hoisting machine mounted at a high position above the car. The hoisting machine typically comprises a drive wheel engaging hoisting ropes suspending on opposite sides thereof an elevator car and a counterweight. The ropes typically pass either from the car or the counterweight to a rope anchoring device via which the ropes continue unbroken to a rope supply storage.

When a portion of the elevator hoistway under construction higher than the hoisting machine has reached a sufficient stage of completion, the completed part of the elevator hoistway can be taken into use. At this stage a configuration change, hereinafter also referred to as “a jump”, is performed, wherein typically the hoisting machine and the rope anchoring devices are hoisted to a new higher position. Thereafter, the car can reach a higher position than before the jump and start serving the additional floors. The releasable anchoring device can be released to allow moving of rope via it from a rope supply storage for thereby increasing length of the rope on opposite side of the rope anchor. By releasing the rope anchor and thereafter pulling rope via the rope anchor, the length of the hoisting ropes between the rope anchors can be extended longer in the configuration change. The pulling can be simply produced, e.g. by hoisting of the rope anchor(s) and/or the drive wheel of the hoisting machine unit around which drive wheel the hoisting ropes 2 pass.

In prior art, there have been anchoring devices provided with one or more rope grippers each having a pair of gripping members movable towards each other to compress a rope or ropes placed between them. These grippers have produced the function holding the ropes immovable when closed.

Hoisting ropes of construction time elevator arrangements are typically metal wire ropes. This kind of ropes endure relatively well compression for anchoring them.

A drawback of the known systems has been that tight compression of the ropes may be harmful for rope structure. Indents or deformations or other damages in the rope structure caused by the gripping, may cause problems already during construction time use. It is also common that the ropes need to be changed after the elevator is taken in final use. This is relatively expensive, laborious and time consuming work since the elevators are typically high rise elevators.

### BRIEF DESCRIPTION OF THE INVENTION

The object of the invention is to introduce an improved elevator arrangement and method for constructing an elevator.

An object is particularly to introduce a new solution by which one or more of the above-mentioned problems of prior art and/or drawbacks discussed or implied elsewhere in the description can be alleviated.

An object is particularly to provide a solution where rope anchoring can be achieved firmly yet gently.

It is brought forward a new elevator arrangement comprising a hoistway; and one or more hoisting ropes; and a rope supply storage; and an elevator car and a counterweight in the hoistway, which elevator car and counterweight are interconnected by the one or more hoisting ropes; and a hoisting machine unit mounted in a first hoisting machine position in the hoistway; and a rope anchoring device mounted in a first rope anchor position in the hoistway. The rope anchoring device comprises a support structure and one or more rope wheels for guiding the one or more ropes. Said one or more rope wheels are rotatably mounted on said support structure. The one or more hoisting ropes pass from the rope supply storage to the rope anchoring device, around the one or more rope wheels thereof, and from the rope anchoring device to one of the car and counterweight. Each said rope has a surface material which is or comprises polymer, and the one or more rope wheels comprise at least one rope wheel provided to be lockable from rotating [also referred to as lockable rope wheel]. With this kind of solution one or more of the above-mentioned objects can be facilitated.

With this solution particularly a well holding and gentle anchoring of the ropes can be achieved. In the arrangement, a frictional engagement of each rope with the lockable rope wheel is facilitated by the surface material of the rope as well as long contact area provided by the rim of the lockable rope wheel. The engagement is also facilitated by that rope tension on opposite sides of a rope wheel tends to increase the normal force, which reduces need for compression of the rope (or even eliminates this) against the lockable rope wheel. Thus, the lockable rope wheel, when locked unrotatable, can hold the ropes immovable via said frictional engagement and thereby facilitate a reliable anchoring function.

Preferable further details of the arrangement are introduced in the following, which further details can be combined with the rope arrangement individually or in any combination.

In a preferred embodiment, the rope anchoring device comprises a locking mechanism shiftable between a locked state and an unlocked state, wherein in said locked state the locking mechanism locks said lockable rope wheel to be unrotatable relative to the support structure, and wherein in said unlocked state the locking mechanism allows said lockable rope wheel to rotate relative to the support structure.

In a preferred embodiment, the one or more hoisting ropes pass from said one of the car and counterweight to the hoisting machine unit, around the drive wheel thereof, and from the hoisting machine unit to the other of said car or counterweight, and therefrom to a second rope anchoring device.

In a preferred embodiment, the locking mechanism is in the locked state, and the elevator arrangement is in operation where the car thereof is moved by the hoisting machine unit for transporting passengers and/or goods in particular in response to signals from one or more user interfaces.

In a preferred embodiment, the one or more hoisting ropes are arranged to engage the rim of the lockable rope wheel by friction and the lockable rope wheel, when locked unrotatable, holds the rope(s) immovable via the frictional engagement.

In a preferred embodiment, the surface material of the one or more hoisting ropes is in contact with the rim of the lockable rope wheel.

In a preferred embodiment, the wrap angle between the one or more hoisting ropes and the lockable rope wheel is more than 90 degrees.

In a preferred embodiment, the lockable rope wheel is grooved, i.e. it comprises a grooved rim, and each of said one or more hoisting ropes is positioned in a groove of the lockable rope wheel.

In a preferred embodiment, the locking mechanism comprises one or more locking members operable to move between a first position where it/they blocks/block the rope wheel from rotating relative to the support structure and a second position where it/they doesn't/don't block the rope wheel from rotating relative to the support structure. Preferably, the locking member is movable between said positions manually. Alternatively, the rope anchoring device comprises an actuator, such as a solenoid or electromagnet for example, for moving the locking member between said positions.

In a preferred embodiment, the locking member is a locking pin inserted or at least insertable to extend in an opening of the support structure and in an opening of the rope wheel or alternatively of a part rigidly connected to it. The locking pin is then in particular in its first position inside both said openings, and it is movable out from at least one of said openings so as to move it to its second position.

In a preferred embodiment, the surface material is or comprising polyurethane, rubber or silicone.

In a preferred embodiment, each said rope has one or more load bearing members coated by said surface material.

In a preferred embodiment, the load bearing members are metal cords or composite rods or non-metallic fiber cords.

In a preferred embodiment, the arrangement comprises a releasable rope gripper arranged to grip first sections of the one or more hoisting ropes, wherein each said first section extends between the supply storage and a lockable rope wheel of the rope anchoring device and/or second sections of the one or more hoisting ropes, wherein each second section extends between a lockable rope wheel of the rope anchoring device and said one of the car and counterweight.

In a preferred embodiment, said one or more releasable rope grippers include at least one gripper arranged to grip both said first and section sections of a same rope; or said one or more releasable rope grippers include at least one gripper arranged to grip said first section and mounted on the support structure and/or at least one gripper arranged to grip said second section and mounted on the support structure.

In a preferred embodiment, the arrangement comprises a pressing arrangement for pressing the one or more ropes against the lockable rope wheel. Preferably, the pressing arrangement comprises an actuator and a pressing member movable by the actuator, the one or more ropes passing between the pressing member and the lockable rope wheel. Preferably, the pressing member is movable by the actuator towards the rope wheel and the one or more ropes resting on the rope wheel between the pressing member and the pressing member. The pressing member is arranged to exert pressure on a side face of the one or more ropes. The actuator can be for instance a hydraulic actuator such as a hydraulic cylinder-piston unit, or an electric actuator of any kind, or a spring, for example.

In a preferred embodiment, said one or more rope wheels comprise a motorized rope wheel, the rope anchoring device comprising an electric motor connected to the motorized rope wheel, the motor being operable to rotate the motorized rope wheel and/or to brake rotation of the motorized rope wheel. Thus, control of movement of the ropes can be improved. Preferably, the motorized rope wheel is also a lockable rope wheel, whereby the anchoring device can be made with small amount of rope wheels.

In a preferred embodiment, the motor is connected to a user interface, such as an operating device, operable by a user for controlling the motor.

In a preferred embodiment, the user interface comprises a button, such as a push button or a touch button, pressing of which causes rotation of the motor to first direction, and a button, such as a push button or a touch button pressing of which causes rotation of the motor to second direction.

In a preferred embodiment, the gripper comprises a stack of gripping members movable towards each other to compress a rope or ropes placed between opposing gripping members.

In a preferred embodiment, the ropes are circular in cross section.

In a preferred embodiment, the rope has a coating made of said surface material which is or comprises polymer.

In a preferred embodiment, the rope anchoring device is mounted in its first rope anchoring device position on one or more guide rails of the elevator arrangement.

In a preferred embodiment, the rope anchoring device anchors the one or more hoisting ropes such that it provides suspension force via the one or more hoisting ropes for the one of the car and counterweight to which the one or more hoisting ropes pass from the anchoring device.

It is also brought forward a new method for constructing an elevator comprising providing an elevator arrangement as defined anywhere above or in the claims of the application; and thereafter performing a configuration change. The configuration change comprises releasing an anchoring of the one or more hoisting ropes comprising unlocking the at least one lockable rope wheel for allowing rotation thereof, preferably comprising shifting the locking mechanism(s) of the at least one rope wheel from the locked state to the unlocked state; and hoisting the hoisting machine unit and/or the rope anchoring device; and moving rope via the rope anchoring device from the rope supply storage for thereby increasing length of the one or more hoisting ropes on opposite side of the rope anchoring device; and mounting the hoisting machine unit to a second hoisting machine position, which is higher than the first hoisting machine position and/or the rope anchoring device to a second rope anchoring device position, which is higher than the first rope anchoring device position; and anchoring the one or more hoisting ropes, comprising locking the at least one lockable rope wheel for preventing rotation thereof, preferably comprising shifting the locking mechanism(s) of the at least one rope wheel from the unlocked state to the locked state.

With this kind of solution one or more of the above-mentioned objects can be facilitated. Preferable further details of the method are introduced in the following, which further details can be combined with the method individually or in any combination.

In a preferred embodiment, the method comprises, in particular after said providing and before said configuration change, moving the elevator car for transporting passengers and/or goods with the hoisting machine unit while the hoisting machine unit and the rope anchoring device are in their first positions. Preferably, said moving is performed in response to signals from one or more user interfaces.

In a preferred embodiment, the method comprises, in particular after the performing configuration change, moving the elevator car for transporting passengers and/or goods with the hoisting machine unit while the hoisting machine unit and the rope anchoring device are in their second positions. Preferably, said moving is performed in response to signals from one or more user interfaces.

In a preferred embodiment, the unlocking the at least one lockable rope wheel for allowing rotation thereof comprises shifting the locking mechanism(s) of the at least one rope wheel from the locked state to the unlocked state and the locking comprises shifting the locking mechanism(s) of the at least one rope wheel from the unlocked state to the locked state.

In a preferred embodiment, said releasing the anchoring comprises releasing the one or more rope grippers and the anchoring comprises closing the one or more rope grippers.

In a preferred embodiment, the rope anchoring device is mounted in its first rope anchoring device position and in its second rope anchoring device position on one or more guide rails of the elevator arrangement.

Generally, the car preferably comprises an interior wherein passenger and/or goods can be transported. The car preferably also comprises one or more doors by which the interior can be opened and closed. The door is preferably an automatic door, whereby comfortable and safe elevator use can be provided by the elevator solution.

### BRIEF DESCRIPTION OF THE DRAWINGS

In the following, the present invention will be described in more detail by way of example and with reference to the attached drawings, in which

FIG. 1 illustrates a schematic side view of an elevator arrangement according to a first embodiment, as well as a phase in a method according to an embodiment.

FIG. 2 illustrates a partial view of a phase in the method following the phase of FIG. 1.

FIG. 3 illustrates a phase in the method following the phase of FIG. 2.

FIG. 4 illustrates preferred details of the anchoring device of FIGS. 1-3.

FIG. 5 illustrates preferred details of the hoisting rope of all the embodiments.

FIG. 6 illustrates preferred details of the gripper of FIGS. 1-3 and 7.

FIGS. 7 and 8 illustrate preferred details of an elevator arrangement according to a second embodiment.

FIG. 9 illustrates preferred details of an elevator arrangement according to a third embodiment.

FIG. 10 illustrates preferred details of an elevator arrangement according to a fourth embodiment.

FIG. 11 illustrates preferred details of the gripper of FIGS. 9 and 10.

FIGS. 12 and 13 illustrate vertical views of preferred alternative layouts for the elevator arrangement.

### DETAILED DESCRIPTION

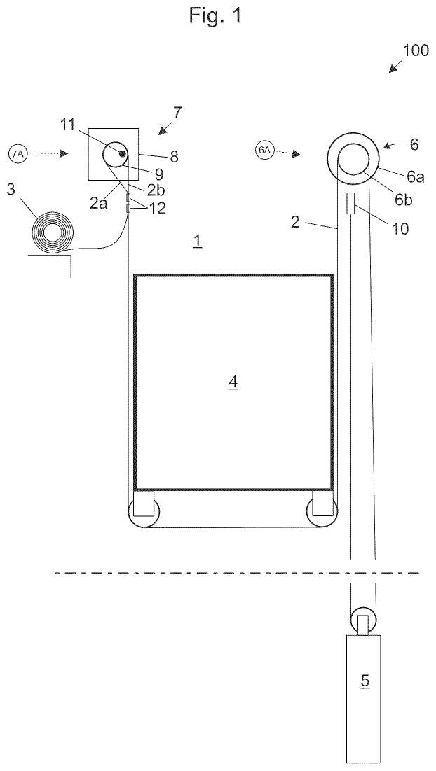

FIG. 1 illustrates an elevator arrangement 100 according to a first embodiment. The elevator arrangement 100 comprises a hoistway 1; and one or more hoisting ropes 2; and an elevator car 4 and a counterweight 5 in the hoistway 1, which elevator car 4 and counterweight 5 are interconnected by the one or more hoisting ropes 2.

The elevator arrangement 100 is in particular a construction time elevator arrangement, where the upper parts of the hoistway and/or structures to be mounted therein and/or upper parts of a building comprising the hoistway is/are still under construction or even non-existent.

The elevator arrangement 100 comprises a hoisting machine unit 6 mounted in a first hoisting machine position 6A in the hoistway 1; and a rope anchoring device 7 mounted in a first rope anchor position 7A in the hoistway 1. The rope anchoring device 7 comprises a support structure 8 and one or more rope wheels 9 for guiding the one or more hoisting ropes 2, which one or more rope wheels 9 are rotatably mounted on said support structure 8. The elevator arrangement 100 further comprises a rope supply storage 3 and the one or more hoisting ropes 2 pass from the rope supply storage 3 to the rope anchoring device 7, around the one or more rope wheels 9 thereof, and from the rope anchoring device 7 to one of the car 4 and counterweight 5 [here to the car 4], and from said one of the car 4 and counterweight 5 to the hoisting machine unit 6, around the drive wheel 6a thereof, and from the hoisting machine unit 6 to the other of said car 4 or counterweight 5, and therefrom to a second rope anchoring device 10.

The one or more rope wheels 9 being rotatably mounted on said support structure 8 provides each said rope wheel 9 can rotate when the one or more ropes 2 are made to run around it to move from one side of each rope wheel 9 to the other side of it during a configuration change. This facilitates moving of the one or more ropes 9 from one side of the anchoring device 7 to the other side thereof during the configuration change.

The one or more rope wheels 9 comprise a rope wheel 9 provided to be lockable from rotating [also referred to as lockable rope wheel].

For achieving said lockability, the rope anchoring device 7 comprises a locking mechanism 11 shiftable between a locked state and an unlocked state, wherein in said locked state the locking mechanism 11 locks said lockable rope wheel 9 to be unrotatable relative to the support structure 8, and wherein in said unlocked state the locking mechanism 11 allows said lockable rope wheel 9 to rotate relative to the support structure 8.

In the embodiment of FIG. 1, the locking mechanism 13 is in the locked state, and the elevator arrangement 100 is in operation where the car 4 thereof is moved by the hoisting machine unit 6 for transporting passengers and/or goods in particular in response to signals from one or more user interfaces [not shown].

Each said rope 1 has a surface material which is or comprises polymer. The surface here refers to the outer surface of the rope 2. Polymer surface ropes generally have a relatively high coefficient of friction in their engagement with a rope wheel or at least easily adjustable to have a high coefficient of friction, e.g. compared to metal surface ropes. Polymer surface also has elasticity and it with a relatively small pressure it sets tightly and with large contact area against another surface. Thus, in the arrangement 100 the frictional engagement of each rope 1 with the lockable rope wheel 9 is facilitated by the surface material. This provides that when the lockable rope wheel 9 is locked from rotating, as illustrated in FIG. 1, the ropes 1 engage with relatively good frictional engagement with the rim of the lockable rope wheel 9 and the rope wheel 9 locked unrotatable can hold the ropes immovable via said frictional engagement. The engagement length between each said rope 1 and the lockable rope wheel 9 can be simply made relatively long by arranging the ropes 1 to pass a wide wrap angle around the lockable rope wheel 9, the wrap angle preferably being more than 90 degrees, as illustrated. A long engagement length provides a vast total contact area, which facilitates achieving a well holding engagement.

The lockable rope wheel 9 is grooved, i.e. it comprises a grooved rim, and each of said one or more hoisting ropes 2 is positioned in a groove of the lockable rope wheel 9. This provides that the lateral position of the ropes 2 is well controlled, as well as increases the holding ability of the frictional engagement. Generally, the grooves can have any suitable groove shape. They may have round or flat side flanks, and they may be undercut or not.

The arrangement 100 comprises a releasable rope gripper 12, more precisely two of them. The rope gripper 12 is arranged to grip first sections 2a of the one or more hoisting ropes 2, wherein each said first section 2a extends between the supply storage 3 and the lockable rope wheel 9 of the rope anchoring device 7 as well as second sections 2b of the one or more hoisting ropes 2, wherein each second section 2b extends between the lockable rope wheel 9 of the rope anchoring device 7 and said one of the car 4 and counterweight 5 [here the car 4]. The rope gripper 12 thus grips both said first and second section 2a, 2b of each said hoisting rope 2. This provides that movement and/or tension of the second section 2b can increase tension of the first section 2a, which increases the normal force of the ropes on the lockable wheel 9, whereby the frictional engagement is well maintained firm, and the lockable wheel 9, when locked, is able to hold the ropes immovable [relative to the support structure 8] via the frictional engagement.

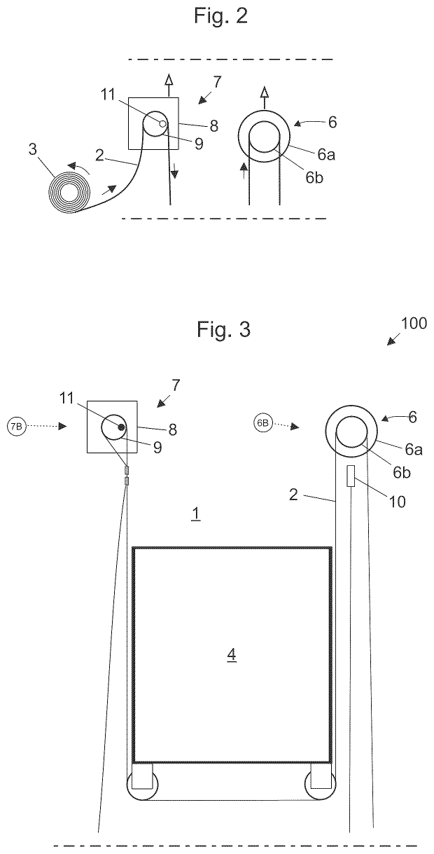

The method for constructing an elevator according to an embodiment, comprises providing an elevator arrangement 100 as defined in any of the preceding claims; and thereafter moving the elevator car 4 for transporting passengers and/or goods with the hoisting machine unit 6 while the hoisting machine unit 6 and the rope anchoring device 7 are in their first positions 6A,7A. Thereafter, the method comprises performing a configuration change comprising releasing an anchoring of the one or more hoisting ropes 2. This releasing comprises unlocking the at least one lockable rope wheel 9 of the rope anchoring device 7 for allowing rotation thereof. This unlocking preferably more specifically comprises shifting the locking mechanisms 11 of the at least one rope wheel 9 from the locked state to the unlocked state. The releasing furthermore preferably comprises/can comprise releasing the one or more rope grippers 12 if there are any gripping the hoisting ropes 2, as it is the case in the embodiment of FIGS. 1-3 for instance. After said releasing an anchoring, the configuration change comprises hoisting the hoisting machine unit 6 and the rope anchoring device 7; and moving rope 2 via the rope anchoring device 7 from the rope supply storage 3 for thereby increasing length of the one or more hoisting ropes 2 on opposite side of the rope anchoring device 7. Movement of the ropes 2 has been illustrated by solid arrows in FIG. 2. This hoisting step is illustrated in FIG. 2 by upwardly pointing arrows. The locking mechanism 11 is in the unlocked state during the hoisting for enabling moving of the ropes 2 via the via the rope anchoring device 7 from the rope supply storage 3. The hoisting can be implemented by any means able to hoist, such as a hoisting arrangement comprising an auxiliary hoist [not shown], or a crane for instance. The hoisting can be generally implemented in any known way for instance. The configuration change moreover comprises mounting the hoisting machine unit 6 to a second hoisting machine position 6B, which is higher than the first hoisting machine position 6A and the rope anchoring device 7 a second rope anchoring device position 7B, which is higher than the first rope anchoring device position 7A, and anchoring the one or more hoisting ropes 2. The anchoring the one or more hoisting ropes 2 comprises locking the at least one lockable rope wheel 9 for preventing rotation thereof. This locking preferably more specifically comprises shifting the locking mechanisms 11 of the at least one rope wheel 9 from the unlocked state to the locked state. The anchoring furthermore preferably comprises/can comprise closing the one or more rope grippers 12 and if there are any provided for gripping the hoisting ropes 2, as it is the case in the embodiment of FIGS. 1-3. FIG. 3 illustrates the arrangement after the configuration change is finished.

Owing to the hoisting, the car 4 can now be made to move to a higher position than before the configuration change and start serving additional floors. In said hoisting, preferably both the hoisting machine unit 6 and the rope anchoring device 7 are hoisted so as to achieve a fully performed jump, but this is not necessary since for achieving higher travel of the car 4 at least hoisting of the hoisting machine unit 6 is may be sufficient. In the hoisting machine unit 6 and the rope anchoring device 7, these can also be hoisted together or separately. The second anchoring device 10 is preferably also hoisted in the hoisting step but this too is not necessary for achieving higher travel of the car 4.

The method further comprises, after performing the configuration change, moving the elevator car 4 for transporting passengers and/or goods with the hoisting machine unit 6 while the hoisting machine unit 6 and the rope anchoring device 7 are in their second positions 6B,7B.

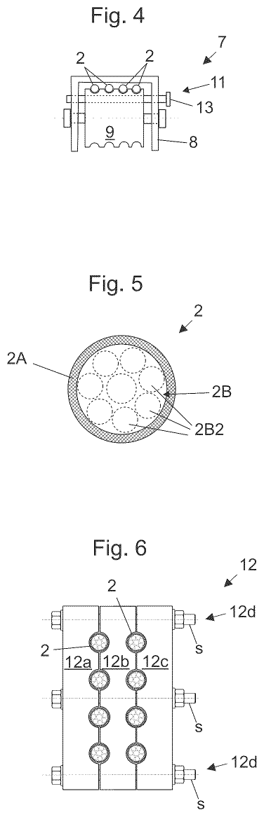

FIG. 4 illustrates preferred details of the rope anchoring device 7 of the embodiment of FIG. 1. In this embodiment, the locking mechanism 11 comprises a locking member 13 operable to move between a first position where it/they blocks/block the rope wheel 9 from rotating relative to the support structure 8 and a second position where it/they does/do not block the rope wheel 9 from rotating relative to the support structure 8. FIG. 4 illustrates the locking member 13a in said first position. In the illustrated embodiment, the locking member 13 is a locking pin inserted or at least insertable to extend in an opening of the support structure 8 and in an opening of the rope wheel 9 [as illustrated] or alternatively of a part rigidly connected to it. The locking pin is in its first position inside both said openings, and it is movable out from at least one of said openings so as to move it to its second position.

In the illustrated embodiment, the locking member 13 is movable between said positions manually. Alternatively, the rope anchoring device 10 could comprises an actuator, such as a solenoid or electromagnet, for moving the locking member between said positions.

As above mentioned, each said rope 2 has a surface material which is or comprises polymer. The surface here refers to the outer surface of the rope 2. Generally preferably, the surface material is or at least comprising polyurethane, rubber or silicone, but many alternative polymer materials are available. FIG. 5 illustrates preferred further details of the hoisting rope 2. In this case, the hoisting rope 2 comprises one or more load bearing members 2B coated by said surface material 2A. The rope 2 thereby has a coating made of said surface material 2A which is or comprises polymer. The surface material is illustrated by reference sign 2A in FIG. 5. In the illustrated example, the load bearing member 2B is a metal cord comprising plurality of metal wire strands 2B2 twisted together. As an alternative, it could be a cord comprising plurality of non-metallic fiber strands 2B2 comprising non-metallic fibers twisted together. The structure of the load bearing member 2B is drawn by broken line to illustrate that it could also have some other structure than what is illustrated. For example, it could be a single composite rod comprising reinforcing fibers embedded in polymer matrix.

FIG. 6 illustrates preferred details of the gripper 12 of the embodiment of FIG. 1. The grippers 12 are not necessary but advantageous for providing additional safety.

The gripper 12 comprises a stack of gripping members 12a,12b,12c movable towards each other to compress a rope or ropes 2 placed between opposing gripping members 12a,12b; 12b,12c. The gripping members 12a,12b,12c can each comprise elongated rope grooves for receiving a side portion of a rope 2. The rope gripper 12 comprises a compressing mechanism 12d for compressing the gripping members 12a,12b,12c of the gripper 12 towards each other. The compressing mechanism 12d preferably comprises tigthenable screw members s, such as bolts as illustrated in FIG. 6, extending through the gripping members of the stack. The compressing mechanism 12d preferably comprises plurality of said screw members s, such as two, three or more of them. This facilitates evenness of the compression.

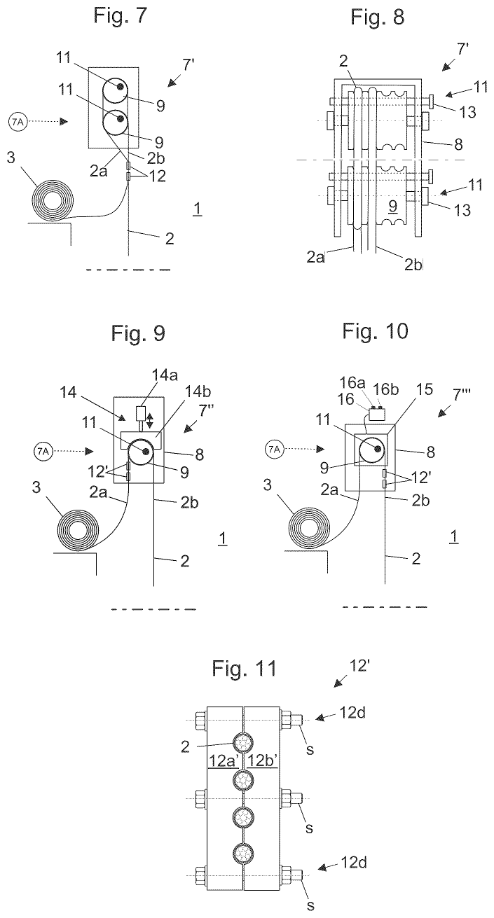

FIG. 7 illustrates a second embodiment of the arrangement 100, which is otherwise as described referring to FIG. 1, but in this case the one or more rope wheels 9 rotatably mounted on said support structure 8 comprise two of said rope wheels 9 provided to be lockable from rotating. Each said rope 2 is arranged to double wrap the two lockable rope wheels 9. Particularly, each said rope 2 is arranged to pass from the rope supply storage 3 to the rope anchoring device 7′, around a first one of said rope wheels 9 the upper one in FIG. 7, therefrom to a second one of said rope wheels 9 the lower one in FIG. 7, and therefrom again to the first one of said rope wheels 9, and therefrom to one of the car 4 and counterweight 5 [here to the car 4]. The double wrap facilitates holding ability of the anchoring device 7, in particular by increasing the contact length between the hoisting ropes 2 and the rope wheels 9 when locked. FIG. 8 illustrates preferred details of the rope anchoring device 7′ of FIG. 7. For the sake of clarity, only one rope 2 is illustrated. As For achieving said lockability, the rope anchoring device 7′ comprises a locking mechanism 11 for each said lockable rope wheel 9 shiftable between a locked state and an unlocked state, wherein in said locked state the locking mechanism 11 locks a lockable rope wheel 9 to be unrotatable relative to the support structure 8, and wherein in said unlocked state the locking mechanism 11 allows said the lockable rope wheel 9 to rotate relative to the support structure 8. The method can be performed as described referring to FIGS. 1-3.

FIG. 9 illustrates a third embodiment of the arrangement 100, which is otherwise as described referring to FIG. 1, but in this case the arrangement, in particular the anchoring device 7″, comprises a pressing arrangement 14 for pressing the one or more ropes 1 against a lockable rope wheel 9 of the anchoring device 7″. Hereby, the normal force of the ropes 2 on the lockable wheel 9 can be increased, whereby the frictional engagement is well maintained firm, and the lockable wheel 9, when locked, is able to hold the ropes immovable [relative to the support structure 8] via a frictional engagement. In the illustrated embodiment, this is implemented such that the pressing arrangement 14 comprises an actuator 14a and a pressing member 14b movable by the actuator 14a to press the one or more ropes 1 passing between the pressing member 14b and the lockable rope wheel.9. The pressing member 14a is movable by the actuator 14a towards the rope wheel 9 and the one or more ropes 2 resting on the rope wheel 9 between the pressing member 14a and the lockable rope wheel 9. The pressing member 14b is arranged to exert pressure on a side face of each of the one or more ropes 2. The actuator 14 can be a hydraulic actuator such as a hydraulic cylinder piston unit, or an electric actuator of any kind or a spring, for example. The method can be performed as described referring to FIGS. 1-3. However, preferably the step of releasing an anchoring further comprises releasing the pressing of the pressing arrangement 14, and the step of anchoring preferably further comprises pressing the one or more ropes 1 against a lockable rope wheel 9 of the anchoring device 7, such as by aid of the actuator 14a.

In the third embodiment, the arrangement 100 moreover preferably comprises one or more releasable rope grippers 12, here two of them, as illustrated in FIG. 9, arranged to grip first sections 2a of the one or more hoisting ropes 2, wherein each said first section extends between the supply storage 3 and a lockable rope wheel 9 of the rope anchoring device 7″. Each said gripper 12 is mounted on the support structure 8. Thus, the grippers 12′ can take support from the support structure 8 and prevent movement of the ropes 2 when they are pulled by rope weight and/the load of the car 4 or counterweight 5 to which the ropes 2 pass from the anchoring device 7, and thereby provide additional safety in the arrangement. Thus mounted and arranged releasable rope grippers 12′ are advantageous for adding safety and could added correspondingly also into other embodiments presented in this application.

FIG. 10 illustrates a fourth embodiment of the arrangement 100, which is otherwise as described referring to FIG. 1, but in this case said one or more rope wheels 9 of the rope anchoring device 7″′ comprise a motorized rope wheel 9. In this case, the rope anchoring device 7″′ comprises an electric motor 15 connected to the motorized rope wheel 9, the motor 15 being operable to rotate the motorized rope wheel 9 and/or to brake rotation of the motorized rope wheel 9. Thus, rope 2 can be moved from one side of the motorized rope wheel 9 to the other side during the configuration change and thereby it is possible to control rope length as desired. Additionally or alternatively, the motor 15 can be used for braking, i.e. the rope 2 can be resisted from freely running from one side of the motorized rope wheel 9 to the other side during the configuration change and thereby control rope length as desired. The motor 15 can also be used to hoist the one of the car 4 or counterweight 5 [here the car] to which the ropes 2 pass from the rope anchoring device 7″′. Thus, close to the end of the configuration change, such as after the hoisting and before the locking, the one of the car 4 or counterweight 5 can be lifted closer to the hoisting machine 6 so as to adjust rope lengths optimal for increased lifting height. In the preferred embodiment of FIG. 10, the motor 15 is connected to a user interface 16, such as an operating device, operable by a user for controlling the motor 15. Thus, a user, such as a fitter person, can operate the motor 15. The user interface 16 preferably comprises a button 16a, such as a push button or a touch button, pressing of which causes rotation of the motor 15 to first direction, and a button 16b, such as a push button or a touch button pressing of which causes rotation of the motor 15 to second direction. Preferably, the motorized rope wheel 9 is also a lockable rope wheel, whereby the anchoring device 7″′ can be made with small amount of rope wheels.

When the elevator arrangement is according to the fourth embodiment illustrated FIG. 10, where the one or more rope wheels 9 of the rope anchoring device 7″′ comprise a motorized rope wheel 9, the configuration change preferably comprises operating the motor 15 to rotate the motorized rope wheel 9 for moving ropes 2 from one side of the motorized rope wheel 9 to the other side during the configuration change and/or to brake rotation of the motorized rope wheel 9 for resisting the rope[s] 2 from freely running from one side of the motorized rope wheel 9 to the other side during the configuration change. The operating the motor 15 is preferably performed after unlocking the lockable rope wheels 9 of the anchoring device 7.

In the fourth embodiment, the arrangement 100 moreover preferably comprises one or more releasable rope grippers 12′, here two of them, as illustrated in FIG. 10, arranged to grip the second sections 2a of the one or more hoisting ropes 2, wherein each said first section extends between the a lockable rope wheel 9 of the rope anchoring device 7″′ and said one of the car 9 and counterweight 10. Each said gripper 12′ is mounted on the support structure 8. Thus, they can prevent movement of the ropes 2 pulled by rope weight and/the load of the car 4 or counterweight 5 to which the ropes 2 pass from the anchoring device 7 and thereby provide additional safety in the arrangement. Thus mounted and arranged releasable rope grippers 12′ are advantageous for adding safety and could added correspondingly also into other embodiments presented in this application.

The gripper 12′ comprises a stack of gripping members 12a′,12b′ movable towards each other to compress a rope or ropes 2 placed between opposing gripping members 12a′,12b′. The gripping members 12a′,12b′ can each comprise elongated rope grooves for receiving a side portion of a rope 2. The rope gripper 12′ comprises a compressing mechanism 12d for compressing the gripping members 12a,12b of the gripper 12′ towards each other. The compressing mechanism 12d preferably comprises tigthenable screw members s, such as bolts as illustrated in FIG. 11, extending through the gripping members of the stack. The compressing mechanism 12d preferably comprises plurality of said screw members s, such as 2, 3 or more of them. This facilitates evenness of the compression.

Generally preferably, the hoisting machine unit 6 and/or the rope anchoring device 7; 7′; 7″; 7″′ and/or the rope anchoring device 10 can be mounted in the arrangement and method on any suitable structure of the elevator arrangement, but preferably on one or more guide rails 51-54 of the elevator arrangement. This kind of solution is simple because then in the configuration change the hoisting machine unit 6 and/or the anchoring device 7; 7′; 7″; 7″′ can be simply remounted to the higher position on the same guide rail(s) that it/they was/were mounted when in its/their first position. For example, the guide rails 51-54 can be constructed during use of the elevator car while the anchoring device 7; 7′; 7″; 7″′ and the hoisting machine unit 6 are in their first positions, to extend higher in the hoistway.

The rope anchoring device 7; 7′; 7″; 7″′ is in general preferably mounted by its support structure 8. The support structure 8 is illustrated only schematically in the Figures. It may be for instance comprise a support bracket member and releasable fixing means [e.g. bolts; not showed] for fixing the support bracket to another structure of the elevator arrangement, such as directly to one or more guide rails for example. The support structure 8 may also have a beam-shaped part or portion, whereby for instance fixing to a plurality of guide rails is facilitated. This would also facilitate that other parts, such as the hoisting machine unit 6, could be mounted on the support structure 8 simply. In this case then, the anchoring device 7; 7′; 7″; 7″′ and the hoisting machine unit 6 would share a support structure. Although guide rails provide an advantageous structure to mount the anchoring device 7; 7′; 7″; 7″′ and/or the hoisting machine unit 6 and/or the rope anchoring device 10, this is not necessary. For example, mounting on some other structures, e.g. on the hoistway walls, such as via a movable platform [also known as cathead], is also a possible alternative, as it is the case in many known jump lifts.

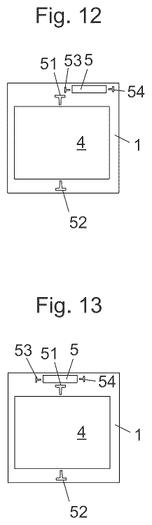

FIGS. 12 and 13 illustrate preferred alternative layouts for the elevator arrangement 100. In these cases, the elevator arrangement 100 comprises a hoistway 1; and guide rail line lines 51-54 in the hoistway 1, comprising at least first guide rails 51,52 for guiding an elevator car 4, and second guide rails 53,54 for guiding a counterweight 5, each guide rail 51-54 preferably comprising a plurality of guide rail sections piled on top of each other. The hoisting machine unit 6 and/or the rope anchoring device 7; 7′; 7″; 7″′ can be mounted in the arrangement and method to be supported by one or more of these guide rails 51-54. Likewise, the rope anchoring device 10 can be mounted to be supported by one or more of these guide rails 51-54.

Generally preferably, the rope supply storage 3 stays stationary during the hoisting step. Generally preferably, the hoisting of the hoisting machine unit 6 and/or the rope anchoring device 7; 7′; 7″; 7″′ produces pulling on the hoisting ropes 2, which can be used for achieving said movement of rope 2 via the rope anchoring device 7; 7′; 7″; 7″′ from the rope supply storage 3. In the embodiment of FIG. 10 this may not necessary if the motor 15 is used for said purpose.

Generally preferably, the ropes 2 are circular in cross section. This is however not necessary, because the ropes 2 could alternatively have some other cross sectional shape.

Generally, the rope supply storage 3 is preferably in the form of one or more rope reels where additional length of hoisting rope 2 can be taken from in a configuration change. The rope supply storage 3 stores an amount of rope that is required for one or more of said configuration changes. For achieving substantial height of jump, the rope supply storage 3 preferably stores more than 10 meters of each said one or more hoisting rope 2, preferably much more such as 20-100 meters.

Generally, the suspension ratio of the car 4 and counterweight 5 can be 2:1 as illustrated in Figures. However, alternatively some other suspension ratio could be used such as 4:1, for example.

Generally, the support structure 8 is in particular a movable support structure. The anchoring device 7; 7′; 7″; 7″′ is mounted in said first position 7A via the support structure 8, and the support structure 8 is dismountable from said first position 7A of the anchoring device 7; 7′; 7″; 7″′ and remountable to a second position aB of the anchoring device 7.

Generally preferably, the compressing mechanism 12d preferably comprises screw members s since such members are simple, reliable and easy to use. The compression mechanism could, however, be also different than what is shown. For example, instead of screw members the compressing mechanism could have some other kind of members tightenable to cause gripping members 12a,12b,12c; 12a′,12b′ to move towards each other to compress a rope or ropes 2 placed between opposing gripping members 12a,12b,12c; 12a′,12b′. Such an alternative solution for tightenening could comprise a handle, for example, turnable to pull the gripping members 12a,12b,12c; 12a',12b′ to move towards each other.

Generally preferably, in each embodiment, the rope anchoring device 7; 7′; 7″; 7″′ is in its first rope anchoring device position 7A mounted inside the hoistway 1. Likewise, in each embodiment, the rope anchoring device 7; 7′; 7″; 7″′ is in its second rope anchoring device position 7B preferably mounted inside the hoistway 1.

Generally preferably, as it is also the case in each embodiment described and illustrated, when the elevator arrangement 100 is in operation where the car 4 thereof is moved by the hoisting machine unit 6 for transporting passengers and/or goods, the rope anchoring device 7; 7′; 7″; 7″′ anchors the one or more hoisting ropes 2 such that it provides suspension force via the one or more hoisting ropes 2 for the one of the car 4 and counterweight 5 to which the one or more hoisting ropes 2 pass from the anchoring device 7; 7′; 7″; 7″′. Then, in particular, said one of the car 4 and counterweight 5 is at least partially suspended by the rope anchoring device 7; 7′; 7″; 7″′ via the the one or more hoisting ropes 2.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims.

1. An elevator arrangement comprising
a hoistway; and
one or more hoisting ropes; and
a rope supply storage; and
an elevator car and a counterweight in the hoistway, which elevator car and counterweight are interconnected by the one or more hoisting ropes; and
a hoisting machine unit mounted in a first hoisting machine position in the hoistway; and
a rope anchoring device mounted in a first rope anchor position in the hoistway, the rope anchoring device comprising a support structure and one or more rope wheels for guiding the one or more ropes, and rotatably mounted on said support structure;
wherein the one or more hoisting ropes pass from the rope supply storage to the rope anchoring device, around the one or more rope wheels thereof, and from the rope anchoring device to one of the car and counterweight;
wherein each said rope has a surface material which is or comprises polymer, and the one or more rope wheels comprise at least one rope wheel provided to be lockable from rotating.

2. An elevator arrangement according to claim 1, wherein the rope anchoring device comprises a locking mechanism shiftable between a locked state and an unlocked state, wherein in said locked state the locking mechanism locks said lockable rope wheel to be unrotatable relative to the support structure, and wherein in said unlocked state the locking mechanism allows said lockable rope wheel to rotate relative to the support structure.

3. An elevator arrangement according to claim 1, wherein the locking mechanism is in the locked state, the elevator arrangement preferably being in operation where the car thereof is moved by the hoisting machine unit for transporting passengers and/or goods in particular in response to signals from one or more user interfaces.

4. An elevator arrangement according to claim 1, wherein the one or more hoisting ropes are arranged to engage a rim of the lockable rope wheel by friction, and the lockable rope wheel, when locked unrotatable, holds the rope(s) immovable relative to the support structure via the frictional engagement.

5. An elevator arrangement according to claim 1, wherein the locking mechanism comprises one or more locking members operable to move between a first position where it/they blocks/block the lockable rope wheel from rotating relative to the support structure and a second position where it/they does/do not block the lockable rope wheel from rotating relative to the support structure.

6. An elevator arrangement according to claim 1, wherein the locking member is a locking pin inserted or at least insertable to extend in an opening of the support structure and in an opening of the rope wheel or alternatively in an opening of a part rigidly connected to it, the locking pin preferably being in its first position inside both said openings and movable out from at least one of said openings so as to move it to its second position.

7. An elevator arrangement according to claim 1, wherein the aforementioned surface material is or comprises polyurethane, rubber or silicone.

8. An elevator arrangement according to claim 1, wherein each said rope has one or more load bearing members coated by said surface material.

9. An elevator arrangement according to claim 1, wherein each said rope has one or more he load bearing members, which are or comprise metal cords or composite rods or non-metallic fiber cords.

10. An elevator arrangement according to claim 1, wherein the arrangement comprises a releasable rope gripper arranged to grip first sections of the one or more hoisting ropes, wherein each said first section extends between the supply storage and a lockable rope wheel of the rope anchoring device and/or second sections of the one or more hoisting ropes, wherein each second section extends between a lockable rope wheel of the rope anchoring device and said one of the car and counterweight.

11. An elevator arrangement according to claim 1, wherein the gripper comprises a stack of gripping members movable towards each other to compress a rope or ropes placed between opposing gripping members.

12. An elevator arrangement according to claim 1, wherein the arrangement comprises a pressing arrangement for pressing the one or more ropes against the lockable rope wheel.

13. An elevator arrangement according to claim 1, wherein the pressing arrangement comprises an actuator and a pressing member movable by the actuator, the one or more ropes passing between the pressing member and the lockable rope wheel.

14. An elevator arrangement according to claim 1, wherein said one or more rope wheels comprise a motorized rope wheel, the rope anchoring device comprising an electric motor connected to the motorized rope wheel, the motor being operable to rotate the motorized rope wheel and/or to brake rotation of the motorized rope wheel.

15. An elevator arrangement according to claim 1, wherein the one or more hoisting ropes pass from said one of the car and counterweight to the hoisting machine unit, around the drive wheel thereof, and from the hoisting machine unit to the other of said car or counterweight, and therefrom to a second rope anchoring device.

16. An elevator arrangement according to claim 1, wherein the rope anchoring device is mounted in its first rope anchoring device position on one or more guide rails of the elevator arrangement.

17. Method for constructing an elevator comprising
providing an elevator arrangement as defined in claim 1; and thereafter
performing a configuration change comprising
releasing an anchoring of the one or more hoisting ropes comprising unlocking the at least one lockable rope wheel for allowing rotation thereof, preferably comprising shifting locking mechanism(s) of the at least one rope wheel from a locked state to an unlocked state; and
hoisting the hoisting machine unit and/or the rope anchoring device; and
moving the one or more hoisting ropes via the rope anchoring device from the rope supply storage for thereby increasing length of the one or more hoisting ropes on opposite side of the rope anchoring device; and
mounting the hoisting machine unit to a second hoisting machine position, which is higher than the first hoisting machine position and/or the rope anchoring device a second rope anchoring device position, which is higher than the first rope anchoring device position; and
anchoring the one or more hoisting ropes, comprising locking the at least one lockable rope wheel for preventing rotation thereof, preferably comprising shifting the locking mechanism(s) of the at least one rope wheel from the unlocked state to the locked state.

18. A method according to claim 17, wherein the method comprises, in particular after said providing and before performing said configuration change, moving the elevator car for transporting passengers and/or goods with the hoisting machine unit while the hoisting machine unit and the rope anchoring device are in their first positions.

19. A method according to claim 17, wherein the method comprises, in particular after the performing the configuration change, moving the elevator car for transporting passengers and/or goods with the hoisting machine unit while the hoisting machine unit and the rope anchoring device are in their second positions.

20. A method according to claim 17, wherein the unlocking the at least one lockable rope wheel for allowing rotation thereof comprises shifting the locking mechanism(s) of the at least one rope wheel from the locked state to the unlocked state and the locking comprises shifting the locking mechanism(s) of the at least one rope wheel from the unlocked state to the locked state.

21. A method according to claim 17, wherein the method comprises said releasing the anchoring comprises releasing the one or more rope grippers and the anchoring comprises closing the one or more rope grippers.

22. A method according to claim 17, wherein the rope anchoring device is mounted in its first rope anchoring device position and in its second rope anchoring device position on one or more guide rails of the elevator arrangement.
